(19) United States
(12) Patent Application Publication
(10) Pub. No.: US 2026/0326974 A1
(43) Pub. Date: Oct. 22, 2026

(54) INGREDIENT DISTRIBUTION DEVICE

(71) Applicant: Techmagic Inc., Tokyo (JP)

(72) Inventor: Shohei MAWATARI, Tokyo (JP)

(21) Appl. No.: 19/114,965

(22) PCT Filed: Sep. 27, 2023
(86) PCT No.: PCT/JP2023/035180

§ 371 Date: Mar. 25, 2025

(30) Foreign Application Priority Data
Oct. 13, 2022 (JP) 2022-164420

(51) Int. Cl. B65D 25/38; G01G 13/18

(52) U.S. Cl. CPC B65D 25/38; G01G 13/18

(57) ABSTRACT

To provide a downsized ingredient distribution device due to controlling a plurality of clutch units, which are the same number as ingredient distribution units, with one drive unit. The ingredient distribution device includes a plurality of ingredient distribution units that store ingredients and can distribute the ingredients to containers; a drive unit that generates power for driving the ingredient distribution units; the clutch units, which are the same number as the ingredient distribution units, that control transmission of the power generated by the drive unit to the ingredient distribution units; and the control unit that controls operating the ingredient distribution units, driving the drive unit, and the transmission of the power by the clutch units.

### TECHNICAL FIELD

The present invention relates to an ingredient distribution device, and more particularly, to an ingredient distribution device comprising a plurality of ingredient distribution units.

### BACKGROUND ART

In recent years, with the development of rich food culture, there has been a demand for cooking a wide variety of dishes using a wide variety of ingredients. In the restaurant business, because of various reasons such as securing chefs, maintaining cooking skills, and improving the cooking environment, there is a rapid demand for automating cooking, and the demand for automatic cooking equipment for automating cooking has been increasing in recent years.

As an ingredient distribution device that is one element of this automatic cooking equipment and for automatically distributing the amount of ingredients required for cooking dishes to containers, it is conventionally known an ingredient distribution device comprising ingredient distribution units that distribute ingredients to containers, and a warming cabinet that incorporates the ingredient distribution units and stores the ingredients stored in the ingredient distribution units in a warm state, wherein the ingredient distribution units are arranged in the upper-lower direction and the left right direction in the warming cabinet for each type of the ingredients, and each of the ingredient distribution units has an ingredient stocker provided inside the warming cabinet for storing the ingredient, an ingredient measuring means incorporated in the warming cabinet for fractionating and measuring the ingredient, and an ingredient sending means incorporated in the warming cabinet for sending the ingredient stored in the ingredient stocker to the ingredient measuring means (for example, patent literature 1).

### CITATION LIST

### Patent Literature

[Patent Literature 1] JP7043702 B (particularly, see FIGS. 2 and 9)

### SUMMARY OF INVENTION

### Technical Problem

In the above-described ingredient distribution device, since the ingredient sending means of each ingredient distribution unit has a drive motor that rotates and drives a screw shaft, the number of the drive motors increases according to the number of the ingredient distribution units, so that the ingredient distribution device becomes larger. Thus, there was room for further improvement in the above-described ingredient distribution device having the plurality of the ingredient distribution units.

Therefore, the object of the present invention is to solve the problems of the prior art as described above. In other words, one of the objects of the present invention is to provide a downsized ingredient distribution device due to controlling a plurality of clutch units, which are the same number as the ingredient distribution units, with one drive unit.

### Solution to Problem

The invention according to claim 1 is an ingredient distribution device comprising: a plurality of ingredient distribution units that store ingredients and can distribute the ingredients to containers; a drive unit that generates power for driving the ingredient distribution units; clutch units, which are the same number as the ingredient distribution units, that control transmission of the power generated by the drive unit to the ingredient distribution units; and a control unit that controls operating the ingredient distribution units, driving the drive unit, and the transmission of the power by the clutch units. Thereby, the above-described problem is resolved.

Here, the “ingredients” are powdered or granular seasonings and powdered or granular ingredients.

The invention according to claim 2 is that, in addition to the configuration of the ingredient distribution device according to claim 1, the drive unit has a drive motor that generates the power and drive gears, which are the same number as the ingredient distribution units, that are provided on a rotating shaft that rotates integrally with the drive motor, the ingredient distribution unit has an ingredient stocker that stores the ingredient, an ingredient measuring means, on which the container is placed, that measures weight of the ingredient distributed to the container, and an ingredient sending means that sends the ingredient stored in the ingredient stocker to the container, and the clutch unit has a cylindrical transmitted side member that engages with a rear end of a connecting shaft of the ingredient sending means, a cylindrical transmitting side member that engages with the drive gear of the drive unit on an outer circumferential surface thereof and is engageable with the transmitted side member in the longitudinal direction, and a pushing member that pushes the transmitting side member to the transmitted side member based on control of the control unit to engage the transmitted side member and the transmitting side member with each other. Thereby, the above-described problem is resolved.

The invention according to claim 3 is that, in addition to the configuration of the ingredient distribution device according to claim 2, the clutch unit has a biasing member that biases the transmitting side member in a direction in which the transmitted side member and the transmitting side member separate from each other. Thereby, the above-described problem is further resolved.

The invention according to claim 4 is that, in addition to the configuration of the ingredient distribution device according to claim 2 or 3, the transmitting side member and the transmitted side member have sawtooth-shaped engaging claws that engage with each other in the longitudinal direction, the engaging claws of the transmitting side member and the transmitted side member have forward direction abutment surfaces, which abut each other when the transmitting side member is rotated in a forward direction in which the ingredient sending means is driven in a direction in which the ingredient is sent to the container, and opposite direction abutment surfaces, which abut each other when the transmitting side member is rotated in a opposite direction opposite to the forward direction, and the forward direction abutment surface of the engaging claw intersects with the rotation axis of the transmitting side member or the transmitted side member in a side view, and an inclination angle of the forward direction abutment surface is gentler than an inclination angle of the opposite direction abutment surface. Thereby, the above-described problem is further resolved.

The invention according to claim 5 is that, in addition to the configuration of the ingredient distribution device according to claim 2 or 3, the ingredient distribution unit has a shutter for opening and closing a discharge opening formed in the ingredient stocker, the control unit controls opening and closing of the discharge opening by the shutter, and when weight of the ingredient distributed to the container reaches predetermined distribution weight, the control unit closes the discharge opening by the shutter and then releases engagement between the transmitting side member and the transmitted side member. Thereby, the above-described problem is further resolved.

### Advantageous Effect of Invention

According to the ingredient distribution device in the invention according to claim 1, the ingredient distribution device comprises: the plurality of the ingredient distribution units that store the ingredients and can distribute the ingredients to the containers; the drive unit that generates the power for driving the ingredient distribution units; the clutch units, which are the same number as the ingredient distribution units, that control the transmission of the power generated by the drive unit to the ingredient distribution units; and the control unit that controls operating the ingredient distribution units, driving the drive unit, and the transmission of the power by the clutch units. Thereby, the control unit controls the clutch unit corresponding to the ingredient distribution unit that stores a predetermined ingredient based on input, and the power generated by the drive unit is transmitted only to the ingredient distribution unit that stores the predetermined ingredient, and the drive unit can drive only a predetermined ingredient distribution unit from the plurality of the ingredient distribution units. Thus, the ingredient distribution device comprising the plurality of the ingredient distribution units can be downsized.

According to the ingredient distribution device in the invention according to claim 2, the clutch unit has the cylindrical transmitted side member that engages with the rear end of the connecting shaft of the ingredient sending means, the cylindrical transmitting side member that engages with the drive gear of the drive unit on the outer circumferential surface thereof and is engageable with the transmitted side member in the longitudinal direction, and the pushing member that pushes the transmitting side member to the transmitted side member based on the control of the control unit to engage the transmitted side member and the transmitting side member with each other. Thereby, the pushing member engages the transmitted side member and the transmitting side member with each other based on the control of the control unit, and the power generated by the drive unit is transmitted only to the predetermined ingredient distribution unit. Thus, in addition to the effect of the ingredient distribution device in the invention according to claim 1, only the predetermined ingredient distribution unit from the plurality of the ingredient distribution units can be driven with a simple mechanism.

According to the ingredient distribution device in the invention according to claim 3, the clutch unit has the biasing member that biases the transmitting side member in the direction in which the transmitted side member and the transmitting side member separate from each other. Thereby, when the pushing member is not pushing the transmitting side member to the transmitted side member, the transmitted side member and the transmitting side member are reliably separated from each other. Thus, in addition to the effect of the ingredient distribution device in the invention according to claim 2, when the pushing member is not pushing the transmitting side member to the transmitted side member, it is possible to reliably prevent the power generated by the drive unit from being transmitted to the ingredient distribution unit.

According to the ingredient distribution device in the invention according to claim 4, the forward direction abutment surface of the engaging claw intersects with the rotation axis of the transmitting side member or the transmitted side member in a side view. Thereby, compared to a case in which the forward direction abutment surfaces are parallel to the rotation axis of the transmitting side member or the transmitted side member in a side view, the transmitting side member can be more easily released from the transmitted side member. Thus, in addition to the effect of the ingredient distribution device in the invention according to claim 2 or 3, when the predetermined distribution weight of the ingredient is sent to the container, the engagement between the transmitting side member and the transmitted side member can be quickly released, so that overdistribution of the ingredient to the container can be prevented and the predetermined distribution weight of the ingredient can be accurately distributed to the container. In addition, the inclination angle of the forward direction abutment surface of the engaging claw is gentler than the inclination angle of the opposite direction abutment surface. Thereby, when the transmitting side member is rotated in the forward direction, the transmitting side member is less likely to come off the transmitted side member than when the transmitting side member is rotated in the opposite direction. Thus, the engagement between the engaging claws of the transmitting side member and the engaging claws of the transmitted side member can be reliably maintained when the transmitting side member rotates in the forward direction, and the amount of the ingredient sent to the container by the ingredient sending means can be accurately managed.

According to the ingredient distribution device in the invention according to claim 5, when the weight of the ingredient distributed to the container reaches the predetermined distribution weight, the control unit closes the discharge opening by the shutter and then releases engagement between the transmitting side member and the transmitted side member. Thereby, when the weight of the ingredient distributed to the container reaches the predetermined distribution weight, the shutter closes the discharge opening and then the engagement between the transmitted side member and the transmitting side member is released. Thus, in addition to the effect of the ingredient distribution device in the invention according to claim 2 or 3, when the weight of the ingredient distributed to the container reaches the predetermined distribution weight, the ingredient will not spill out of the ingredient stocker into the container, and the ingredient can be automatically distributed to the container in an accurate amount.

### BRIEF DESCRIPTION OF DRAWINGS

FIG. 1 is a perspective view of an ingredient distribution device according to one example of the present invention.

FIG. 2A is a perspective view seen from the front of the ingredient distribution device with a housing removed from FIG. 1.

FIG. 2B is a perspective view seen from the rear of the ingredient distribution device with the housing removed from FIG. 1.

FIG. 3 is a perspective view of an ingredient distribution unit and a clutch unit shown in FIG. 2A.

FIG. 4 is a cross-sectional view taken along the line IV-IV in FIG. 3.

FIG. 5A is an exploded perspective view of the main portion of the clutch unit shown in FIG. 2A.

FIG. 5B is a cross-sectional view of the main portion of the clutch unit shown in FIG. 2A.

FIG. 5C is an enlarged side view of the area VC in FIG. 5B.

FIG. 6A is a partial cross-sectional side view of the ingredient distribution unit in an initial state.

FIG. 6B is a partial cross-sectional side view showing a state in which the discharge opening of the ingredient distribution unit shown in FIG. 6A is opened.

FIG. 6C is a partial cross-sectional side view showing a state in which an ingredient is being sent by an ingredient sending means in the ingredient distribution unit.

FIG. 6D is a partial cross-sectional side view showing a state after the ingredient distribution unit has distributed the ingredient to a container.

### DESCRIPTION OF EXAMPLES

The specific embodiment of an ingredient distribution device in the present invention may be arbitrary as long as the ingredient distribution device comprises: a plurality of ingredient distribution units that store ingredients and can distribute the ingredients to containers; a drive unit that generates power for driving the ingredient distribution units; clutch units, which are the same number as the ingredient distribution units, that control transmission of the power generated by the drive unit to the ingredient distribution units; and a control unit that controls operating the ingredient distribution units, driving the drive unit, and the transmission of the power by the clutch units, so that the ingredient distribution device comprising the plurality of the ingredient distribution units can be downsized.

### Example 1

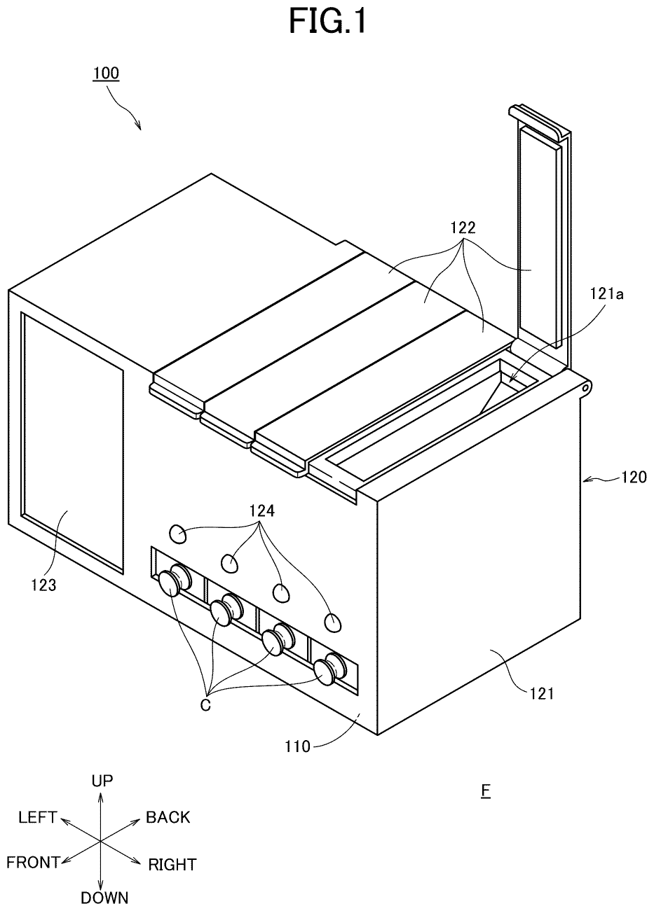

Hereinafter, an ingredient distribution device 100 according to one example of the present invention will be described with reference to FIGS. 1 to 6D.

### 1. Outline of the Ingredient Distribution Device

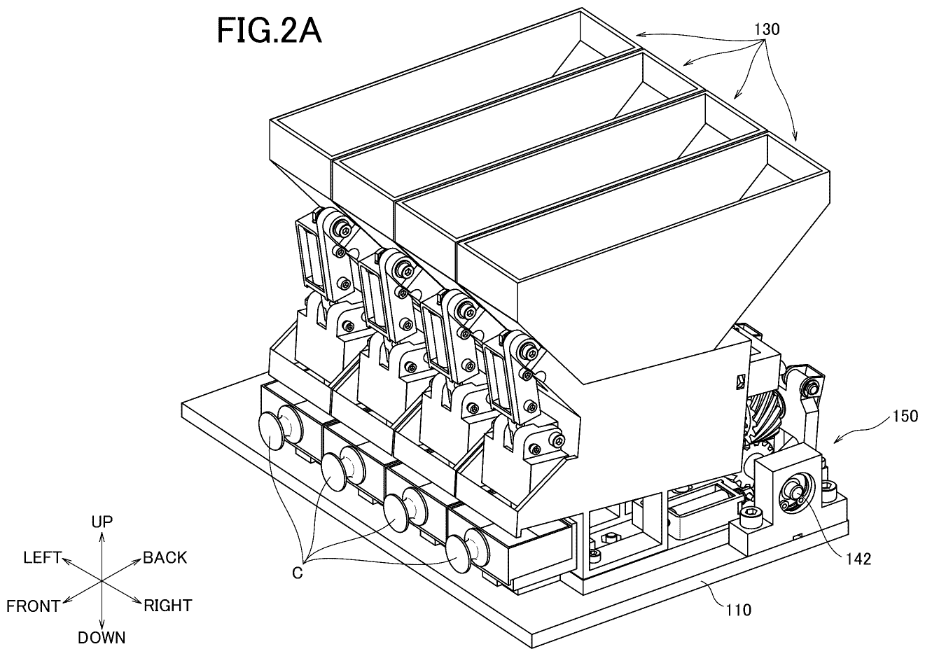

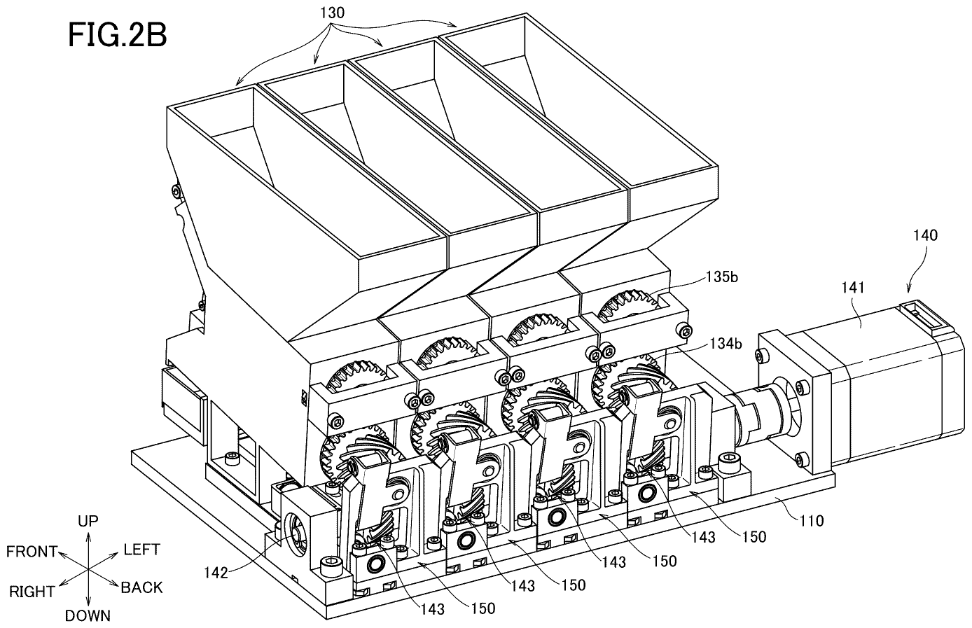

The outline of the ingredient distribution device 100 will be described with reference to FIGS. 1 to 2B.

FIG. 1 is a perspective view of the ingredient distribution device according to one example of the present invention, FIG. 2A is a perspective view seen from the front of the ingredient distribution device with the housing removed from FIG. 1, and FIG. 2B is a perspective view seen from the rear of the ingredient distribution device with the housing removed from FIG. 1.

The ingredient distribution device 100 is a device that stores a plurality of ingredients, such as powdered seasonings such as sugar, salt and pepper, powdered ingredients such as soybean flour, and granular ingredients such as sesame seeds, and distributes them into containers C. As shown in FIG. 1, the device is provided with a base 110 that is placed on a placement surface F, and a housing 120 that covers the base 110 and forms the exterior.

The housing 120 has a rectangular housing main body 121, lids 122 that can open and close openings 121a formed on the top surface of the housing main body 121, a touch panel 123 provided on the front left side of the housing main body 121 for operating the ingredient distribution device 100, and driving lights 124 provided on the front of the housing main body 121 to indicate which ingredient distribution unit 130 is operating.

The lids 122 and the driving lights 124 are the same number as the ingredient distribution units 130 (described later) provided in the housing 120.

As shown in FIGS. 2A and 2B, the ingredient distribution device 100 includes a plurality of the ingredient distribution units 130 placed on and fixed to the base 110, a drive unit 140 placed on and fixed to the base 110, and clutch units 150 attached to the ingredient distribution units 130.

Further, the ingredient distribution device 100 includes a control unit (not shown) that controls operating the ingredient distribution units 130, driving the drive unit 140 and the transmission of power by the clutch units 150.

### 2. Ingredient Distribution Unit

Next, the ingredient distribution units 130 that store ingredients and can distribute them to the containers C will be described with reference to FIGS. 2B, 3 and 4.

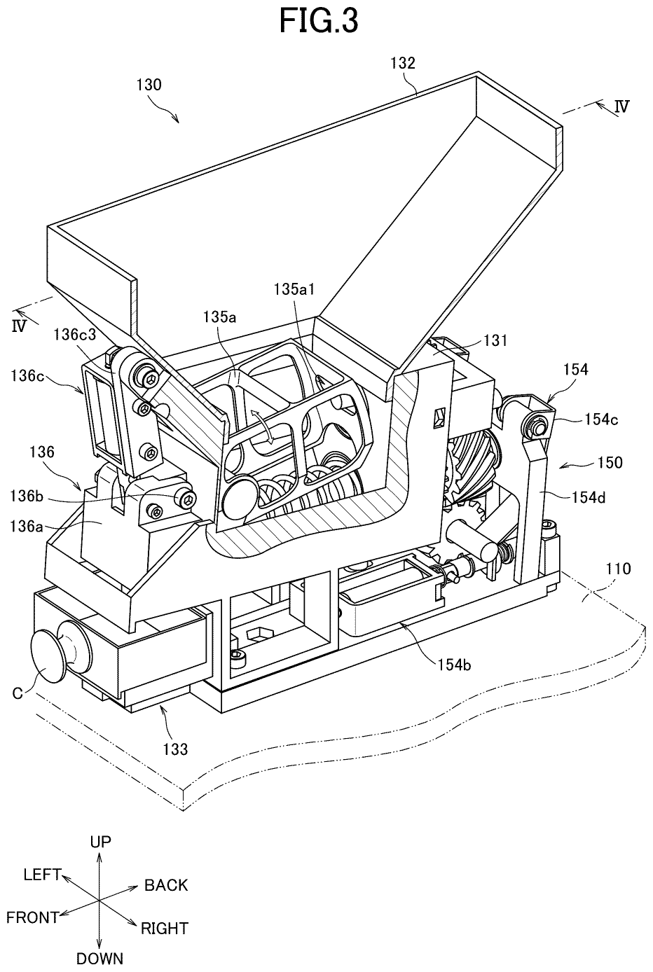

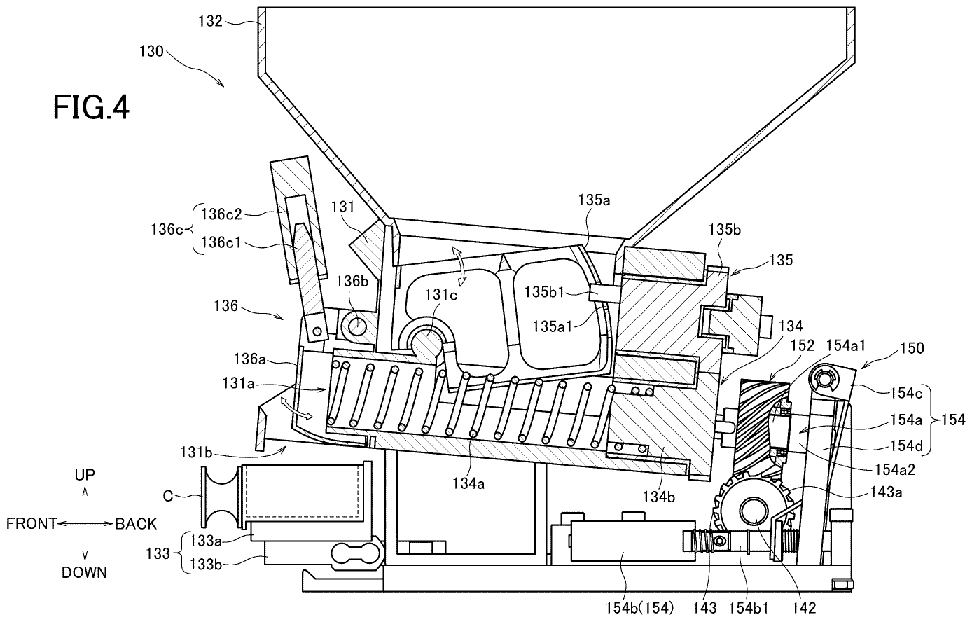

FIG. 3 is a perspective view of the ingredient distribution unit and the clutch unit shown in FIG. 2A, and FIG. 4 is a cross-sectional view taken along the line IV-IV in FIG. 3.

The ingredient distribution unit 130 includes an ingredient stocker 131 that stores the ingredient, a hopper 132 that is attached to an upper opening of the ingredient stocker 131 and distributes the ingredient to the ingredient stocker 131, an ingredient measuring means 133, on which the container C is placed, that measures the weight of the ingredient distributed to the container C, an ingredient sending means 134 that sends the ingredient stored in the ingredient stocker 131 to the container C, an ingredient stirring means 135 that stirs the ingredient stored in the ingredient stocker 131 to suppress the occurrence of the bridging phenomenon, and a shutter 136 that controls discharging the ingredient from the ingredient stocker 131.

The ingredient stocker 131 is rectangular and hollow.

In addition, the front bottom of the ingredient stocker 131 is formed with a discharge opening 131a, which extends in the front-rear direction and through which the ingredient is discharged by the ingredient sending means 134, and an ingredient drop hole 131b which guides the ingredient discharged through the discharge opening 131a and drop the ingredient into the container C.

The ingredient measuring means 133 is composed of a container placing table 133a, which is arranged directly below the ingredient drop hole 131b of the ingredient stocker 131 and on which the container C is placed, and a load cell 133b which measures the weight of the container placing table 133a.

The ingredient sending means 134 has a coil-shaped member 134a, which is arranged inside the ingredient stocker 131 and extends in the front-rear direction, and a connecting shaft 134b which connects with the coil-shaped member 134a and the clutch unit 150.

The coil-shaped member 134a rotates integrally with the connecting shaft 134b to send out the ingredient stored in the ingredient stocker 131 in the front-rear direction, and is arranged at a slight incline facing upward as shown in FIG. 4.

As shown in FIG. 4, the connecting shaft 134b has a front end fitted with the coil-shaped member 134a and a rear end connected to the clutch unit 150.

As shown in FIG. 2B, a gear is formed on the outer periphery of the rear end of the connecting shaft 134b.

The ingredient stirring means 135 has a stirring member 135a, which stirs the ingredient stored in the ingredient stocker 131, and a geared rotating shaft 135b which swings the stirring member 135a in the upper-lower direction.

The stirring member 135a is a frame body that is engaged with a swing shaft 131c so as to be swingable in the upper-lower direction, which is provided inside the ingredient stocker 131 and extends in the left right direction.

As shown in FIGS. 3 and 4, an engagement hole 135a1 is formed on the rear end side of the stirring member 135a.

As shown in FIG. 3, the engagement hole 135a1 extends in the left-right direction.

As shown in FIG. 2B, a gear is formed on the outer periphery of the rear side of the geared rotating shaft 135b and engages with the gear formed on the connecting shaft 134b of the ingredient sending means 134.

Therefore, when the connecting shaft 134b of the ingredient sending means 134 rotates, the geared rotating shaft 135b also rotates.

An engagement protrusion 135b1 is formed on the tip side of the geared rotating shaft 135b, which is inserted into and engages with the engagement hole 135a1 of the stirring member 135a.

Therefore, when the geared rotating shaft 135b rotates, the stirring member 135a swings in the upper-lower direction relative to the swing shaft 131c of the ingredient stocker 131 via the engaging protrusion 135b1.

The shutter 136 has a shutter main body 136a that closes the discharge opening 131a of the ingredient stocker 131, a connecting bolt 136b that connects the shutter main body 136a with the ingredient stocker 131, and a shutter pivoting mechanism 136c that pivots the shutter main body 136a in the upper-lower direction around the connecting bolt 136b.

As shown in FIG. 4, the shutter main body 136a is C-shaped in cross section, and its upper end is connected with the ingredient stocker 131 above the discharge opening 131a of the ingredient stocker 131.

In addition, the shutter main body 136a is pivotable in the upper-lower direction relative to the ingredient stocker 131.

As shown in FIGS. 3 and 4, the shutter pivoting mechanism 136c is a pull-type solenoid (which retracts when current is applied and extends when current is not applied) controlled by the control unit, and has a plunger 136c1 whose tip is connected with the shutter main body 136a, a housing 136c2 that accommodates the plunger 136c1, and a connecting plate 136c3 that connects the housing 136c2 with the ingredient stocker 131.

Therefore, when current is not applied to the shutter pivoting mechanism 136c, the shutter main body 136a closes the discharge opening 131a of the ingredient stocker 131 as shown in FIG. 4, and when current is applied to the shutter pivoting mechanism 136c, the shutter main body 136a opens the discharge opening 131a of the ingredient stocker 131.

The control unit controls the opening and closing of the discharge opening 131a of the ingredient stocker 131 by the shutter 136.

The housing 136c2 is a rectangular frame when viewed from the front, and as shown in FIG. 3, the connecting plate 136c3 is attached to the right side surface thereof.

As shown in FIG. 3, the upper end side of the connecting plate 136c3 is axially supported so as to be pivotable in the upper-lower direction relative to the ingredient stocker 131.

### 3. Drive Unit

Next, the drive unit 140 that generates power for driving the ingredient distribution unit 130 will be described with reference to FIG. 2B and the like.

As shown in FIG. 2B and the like, the drive unit 140 has a drive motor 141 that generates the power, a rotating shaft 142 that rotates integrally with the drive motor 141, and drive gears 143 that are provided on the rotating shaft 142 and rotate integrally with the rotating shaft 142, and generates the power for distributing the ingredients stored in the ingredient distribution units 130 to the containers C.

The drive gears 143 are the same number as the ingredient distribution units 130, and each of the drive gears 143 has helical teeth 143a formed on the outer surface thereof.

### 4. Clutch Unit

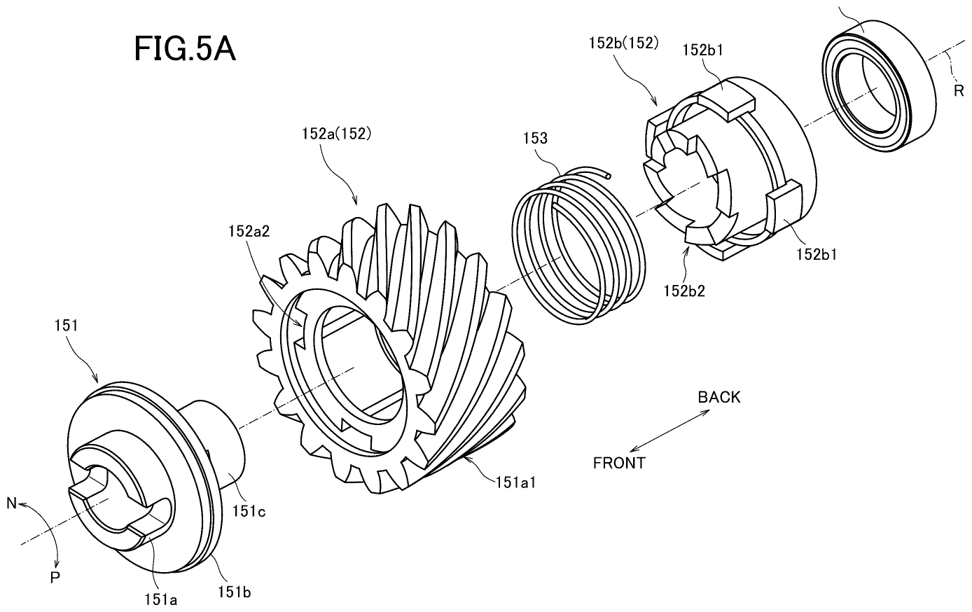

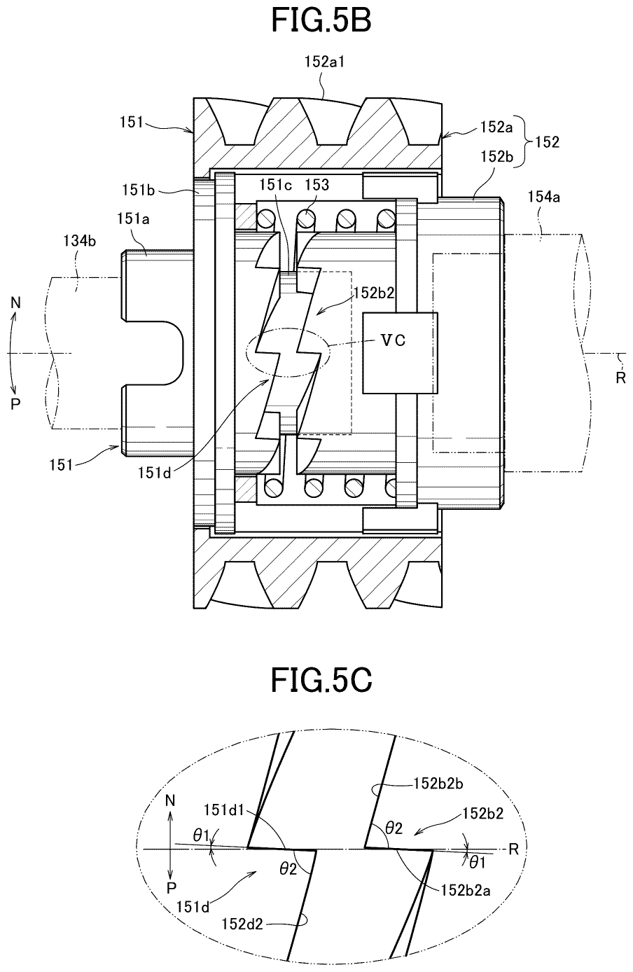

Next, with reference to FIGS. 4, 5A to 5C, the clutch units 150, which are the same number as the ingredient distribution units 130, that control the transmission of the power generated by the drive unit 140 to the ingredient distribution units 130 will be described.

FIG. 5A is an exploded perspective view of the main portion of the clutch unit 150 shown in FIG. 2A, FIG. 5B is a cross-sectional view of the main portion of the clutch unit 150 shown in FIG. 2A, and FIG. 5C is an enlarged side view of the area VC in FIG. 5B.

As shown in FIGS. 5A and 5B, the clutch unit 150 has a cylindrical transmitted side member 151 that engages with the rear end of the connecting shaft 134b of the ingredient sending means 134, a cylindrical transmitting side member 152 that is engageable with the transmitted side member 151 in the longitudinal direction (front-rear direction), a helical spring (biasing member) 153 that is arranged between the transmitted side member 151 and the transmitting side member 152, a pushing member 154 that pushes the transmitting side member 152 to the transmitted side member 151 based on the control of the control unit to engage the transmitted side member 151 and the transmitting side member 152 with each other, and a rolling bearing 155 that is attached to the rear end of the transmitting side member 152.

The transmitted side member 151 is made of resin, and as shown in FIGS. 5A and 5B, has a connecting shaft side cylindrical portion 151a that is connected with the connecting shaft 134b of the ingredient distribution unit 130 from the ingredient distribution unit 130 side, a disk shaped flange portion 151b that is larger in diameter than the connecting shaft side cylindrical portion 151a, a transmitted side cylindrical portion 151c that is smaller in diameter than the flange portion 151b, and engaging claws 151d that protrude from the flange portion 151b toward the transmitting side member 152.

The engaging claws 151d are formed on a concentric circle whose center is a rotation axis R.

The flange portion 151b of the transmitted side member 151 is elastically deformed and fitted into the transmitting side member 152 from the front side.

As shown in FIG. 5A, the transmitting side member 152 is composed of an annular resin gear 152a, which has helical teeth 152a1 that are formed on the outer peripheral surface thereof and engage with the helical teeth 143a formed on the outer peripheral surface of the drive gear 143 of the drive unit 140, and a resin engagement cylinder 152b having a key 152b1 on the outer peripheral surface thereof, which is inserted into a key groove 152a2 formed on the inner peripheral surface side of the gear 152a.

Engaging claws 152b2 that is engageable with the engaging claws 151d of the transmitted side member 151 in the longitudinal direction are formed at the tip of the engagement cylinder 152b.

As shown in FIG. 5A, the engaging claws 152b2 protrude toward the transmitted side member 151 and are formed on a concentric circle whose center is the rotation axis R.

The engaging claws 151d of the transmitted side member 151 and the engaging claws 152b2 of the transmitting side member 152 described above are sawtooth-shaped as shown in FIG. 5C, and are formed of forward direction abutment surfaces 151d1, 152b2a that abut against each other when the transmitting side member 152 is rotated in a forward direction P, and opposite direction abutment surfaces 151d2, 152b2b that abut against each other when the transmitting side member 152 is rotated in an opposite direction N.

As shown in FIG. 5C, the forward direction abutment surfaces 151d1, 152b2a and the opposite direction abutment surfaces 151d2, 152b2b intersect with the rotation axis R in a side view.

As shown in FIG. 5C, an inclination angle θ1 of the forward direction abutment surfaces 151d1, 152b2a is gentler than an inclination angle θ2 of the opposite direction abutment surfaces 151d2, 152b2b.

Therefore, when the transmitting side member 152 rotates in the forward direction P, the forward direction abutment surface 152b2a of the transmitting side member 152 and the forward direction abutment surface 151d1 of the transmitted side member 151 are maintained in contact with each other, and the power generated by the drive motor 141 is transmitted to the connecting shaft 134b of the ingredient distribution unit 130, causing the coil-shaped member 134a to rotate and the ingredient to be sent to the container C.

On the other hand, when the transmitting side member 152 rotates in the opposite direction N, the opposite direction abutment surface 152b2b of the transmitting side member 152 abuts against the opposite direction abutment surface 151d2 of the transmitted side member 151, but slippage occurs between the transmitted side member 151 and the transmitting side member 152, causing the transmitting side member 152 to move away from the transmitted side member 151, and therefore the power generated by the drive motor 141 is not transmitted to the connecting shaft 134b of the ingredient distribution unit 130.

In other words, the inclination angle θ1 of the forward direction abutment surfaces 151d1, 152b2a is gentler than the inclination angle θ2 of the opposite direction abutment surfaces 151d2, 152b2b, as shown in FIG. 5C, so that the power from the drive motor 141 is transmitted to the connecting shaft 134b of the ingredient distribution unit 130 only when the transmitting side member 152 is rotated in the forward direction P.

As shown in FIG. 5B, the spiral spring 153 covers the engaging claws 151d of the transmitted side member 151 and the engagement cylinder 152b of the transmitting side member 152 from the outside, and biases the engagement cylinder 152b of the transmitting side member 152 in a direction in which the transmitted side member 151 and the transmitting side member 152 separate from each other.

The pushing member 154 has a pin 154a that abuts against the rear end side of the engagement cylinder 152b of the transmitting side member 152, a pull-type solenoid 154b in which a plunger 154b1 moves back and forth in the front-rear direction by being controlled by the control unit, an arm 154c that transmits the movement of the plunger 154b1 of the solenoid 154b to the pin 154a, and a frame 154d that supports the arm 154c so that the arm 154c is pivotable in the front-rear direction.

As shown in FIG. 4, the pin 154a has a cylindrical small diameter tip portion 154a1 that abuts against the rear end side of the engagement cylinder 152b of the transmitting side member 152, and a cylindrical large diameter portion 154a2 that is connected with the rear end of the small diameter tip portion 154a1 and is larger in diameter than the small diameter tip portion 154a1.

When current is applied to the solenoid 154b, the force that retracts the plunger 154b1 is greater than the biasing force of the helical spring 153.

In other words, when current is applied to the solenoid 154b, the engaging claws 151d of the transmitted side member 151 and the engaging claws 152b2 of the transmitting side member 152 engage with each other, and when the current to the solenoid 154b is cut off, the engagement between the engaging claws 151d of the transmitted side member 151 and the engaging claws 152b2 of the transmitting side member 152 is released.

As shown in FIG. 4, the arm 154c has a lower end connected with the plunger 154b1 and an upper end supported by the frame 154d so as to be pivotable in the front-rear direction.

Thus, when the plunger 154b1 moves forward (ie, the solenoid 154b retracts), the arm 154c moves forward, and when the plunger 154b1 moves rearward (ie, the solenoid 154b extends), the arm 154c moves rearward.

As shown in FIG. 4, the arm 154c is axially supported by the frame 154d above the pin 154a.

The rolling bearing 155 has an inner diameter that is substantially the same as the outer diameter of the large diameter portion 154a2 of the pin 154a of the pushing member 154, and axially supports the pin 154a so that the pin 154a is rotatable.

The rotation axis of the rolling bearing 155 coincides with the rotation axis R of the transmitting side member 152.

### 5. Ingredient Distribution Procedure

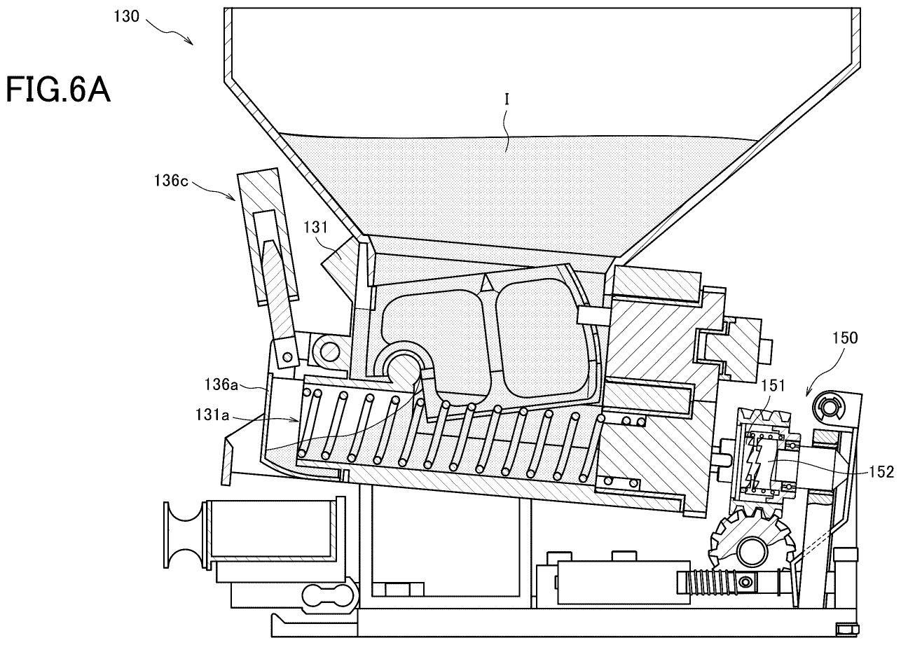

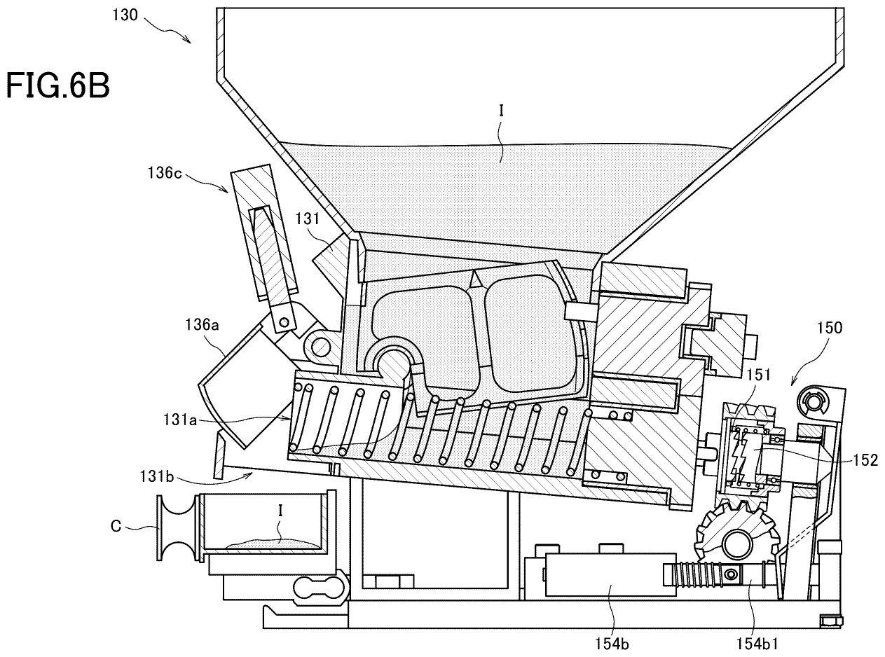

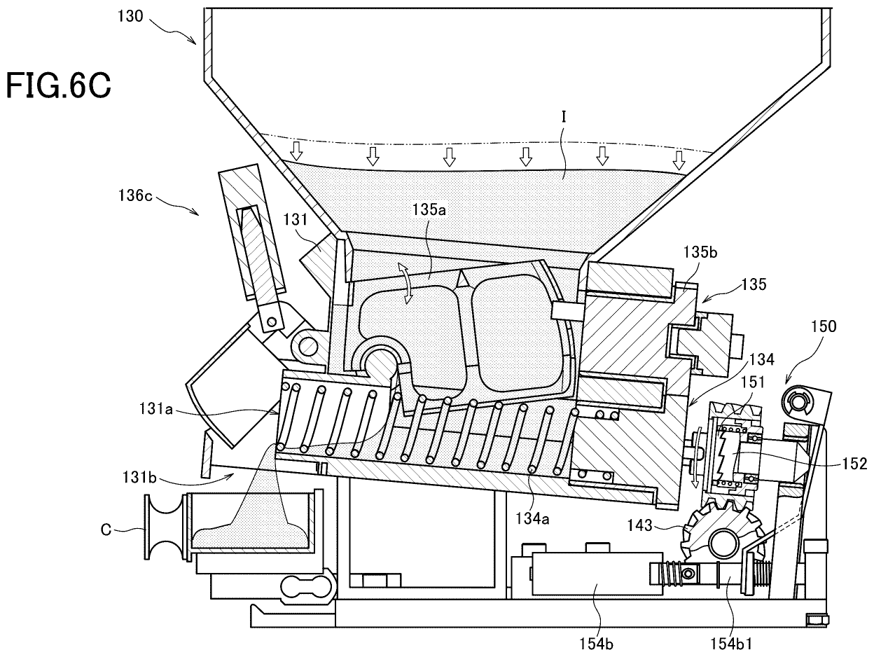

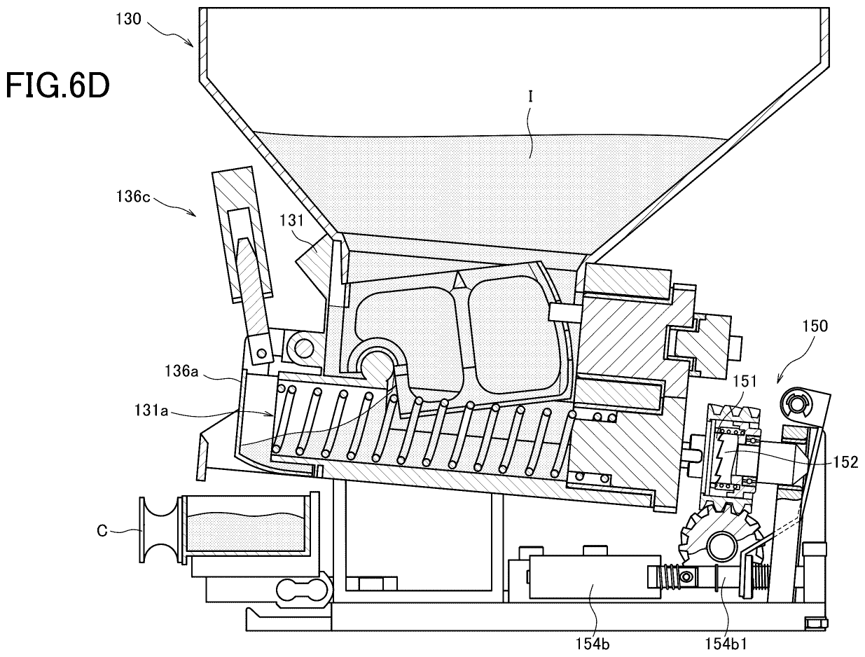

Next, one example of an ingredient distribute procedure by the ingredient distribution unit 130 that stores a specific ingredient I specified by the touch panel 113 will be described with reference to FIGS. 6A to 6D and the like.

FIG. 6A is a partial cross-sectional side view of the ingredient distribution unit 130 in an initial state, FIG. 6B is a partial cross-sectional side view showing a state in which the discharge opening of the ingredient distribution unit 130 shown in FIG. 6A is opened, FIG. 6C is a partial cross-sectional side view showing a state in which the ingredient I is being sent by the ingredient sending means 134 in the ingredient distribution unit 130, and FIG. 6D is a partial cross-sectional side view showing a state after the ingredient distribution unit 130 has distributed the ingredient I to the container C.

It should be noted that the ingredient distribution procedure described below is merely one example, and the ingredient distribution procedure in the ingredient distribution device 100 is not limited to this example.

### 5.1. Initial State

First, the initial state will be described with reference to FIG. 6A.

In the initial state, as shown in FIG. 6A, the ingredient I is stored in the ingredient stocker 131 of the ingredient distribution unit 130.

Further, the discharge opening 131a of the ingredient stocker 131 is closed by the shutter main body 136a.

Furthermore, in the clutch unit 150, the transmitted side member 151 and the transmitting side member 152 are not connected with each other.

### 5.2. Ingredient Distribution

When the specific ingredient I (i.e., the ingredient distribution unit 130 that stores the specific ingredient I) is selected via the touch panel 113 and the weight of the ingredient to be distributed to the container C (hereinafter, this weight will be referred to as the “distribution weight”) is specified, the control unit applies current to the shutter pivoting mechanism 136c of the ingredient distribution unit 130 to open the shutter main body 136a and open the discharge opening 131a of the ingredient stocker 131, as shown in FIG. 6B.

At this time, the ingredient I held by the shutter main body 136a drops into the container C through the ingredient drop hole 131b.

Next, the control unit applies current to the solenoid 154b of the clutch unit 150 to extend the plunger 154b1 to connect the transmitted side member 151 and the transmitting side member 152 with each other, as shown in FIG. 6C.

Then, by driving the drive motor 141 of the drive unit 140, the power generated by the drive motor 141 is transmitted to the connecting shaft 134b of the ingredient distribution unit 130 via the drive gear 143, the transmitting side member 152 and the transmitted side member 151, causing the coil-shaped member 134a of the ingredient sending means 134 to rotate and also causing the geared rotating shaft 135b of the ingredient stirring means 135, which engages with the connecting shaft 134b of the ingredient sending means 134, to rotate.

As a result, as shown in FIG. 6C, the ingredient I in the ingredient stocker 131 is stirred by the swing of the stirring member 135a in the upper-lower direction to suppress the occurrence of the bridging phenomenon, and the ingredient I is discharged from the discharge opening 131a and dropped into the container C through the ingredient drop hole 131b.

### 5.3. Suspension of Distribution

Then, the ingredient sending means 134 sends the ingredient I to the container C until the weight of the ingredient I distributed to the container C reaches the distribution weight, and when the weight of the ingredient I distributed to the container C reaches the distribution weight specified via the touch panel 113, the control unit first cuts off the current applied to the shutter pivoting mechanism 136c, and then, as shown in FIG. 6D, pivots the shutter main body 136a downward to close the discharge opening 131a of the ingredient stocker 131.

Then, the control unit cuts off the current applied to o the solenoid 154b of the clutch unit 150, so that the plunger 154b1 retracts, the engagement between the transmitted side member 151 and the transmitting side member 152 is released, and the state returns to the initial state as shown in FIG. 6A.

### 6. Effects of the Ingredient Distribution Device 100

According to the ingredient distribution device 100 described above, the ingredient distribution device 100 comprises: a plurality of the ingredient distribution units 130 that store the ingredients and can distribute the ingredients to the containers C; the drive unit 140 that generates the power for driving the ingredient distribution units 130; the clutch units 150, which are the same number as the ingredient distribution units 130, that control transmission of the power generated by the drive unit 140 to the ingredient distribution units 130; and the control unit that controls operating the ingredient distribution units 130, driving the drive unit 140, and the transmission of the power by the clutch units 150. Thereby, the control unit controls the clutch unit 150 corresponding to the ingredient distribution unit 130 that stores the predetermined ingredient I based on input, and the power generated by the drive unit 140 is transmitted only to the ingredient distribution unit 130 that stores the predetermined ingredient I, and the drive unit 140 can drive only the predetermined ingredient distribution unit 130 from the plurality of the ingredient distribution units 130. Thus, the ingredient distribution device 100 comprising a plurality of the ingredient distribution units 130 can be downsized.

In addition, the clutch unit 150 has the cylindrical transmitted side member 151 that engages with the rear end of the connecting shaft 134b of the ingredient sending means 134, the cylindrical transmitting side member 152 that engages with the drive gear 143 of the drive unit 140 on the outer circumferential surface thereof and is engageable with the transmitted side member 151 in the longitudinal direction, and the pushing member 154 that pushes the transmitting side member 152 to the transmitted side member 151 based on control of the control unit to engage the transmitted side member 151 and the transmitting side member 152 with each other. Thereby, the pushing member 154 engages the transmitted side member 151 and the transmitting side member 152 with each other based on the control of the control unit, and the power generated by the drive unit 140 is transmitted only to the predetermined ingredient distribution unit 130. Thus, only the predetermined ingredient distribution unit 130 from the plurality of the ingredient distribution units 130 can be driven with a simple mechanism.

Further, the clutch unit 150 has the helical spring 153 as a biasing member that biases the transmitting side member 152 in a direction in which the transmitted side member 151 and the transmitting side member 152 separate from each other. Thereby, when the pushing member 154 is not pushing the transmitting side member 152 to the transmitted side member 151, the transmitted side member 151 and the transmitting side member 152 are reliably separated from each other. Thus, when the pushing member 154 is not pushing the transmitting side member 152 to the transmitted side member 151, it is possible to reliably prevent the power generated by the drive unit 140 from being transmitted to the ingredient distribution unit 130.

In addition, the forward direction abutment surfaces 151d1, 152b2a intersect with the rotation axis R of the transmitting side member 152 or the transmitted side member in 151 a side view. Thereby, compared to a case in which the forward direction abutment surfaces are parallel to the rotation axis of the transmitting side member or the transmitted side member in a side view, the transmitting side member 152 can be more easily released from the transmitted side member 151. Thus, when the predetermined distribution weight of the ingredient I is sent to the container C, the engagement between the transmitting side member 152 and the transmitted side member 151 can be quickly released, so that overdistribution of the ingredient I to the container C can be prevented and the predetermined distribution weight of the ingredient I can be accurately distributed to the container C. In addition, the inclination angle θ1 of the forward direction abutment surfaces 151d1, 152b2a is gentler than the inclination angle θ2 of the opposite direction abutment surfaces 151d2, 152b2b. Thereby, when the transmitting side member 152 is rotated in the forward direction P, the transmitting side member 152 is less likely to come off the transmitted side member 151 than when the transmitting side member 152 is rotated in the opposite direction N. Thus, the engagement between the engaging claws 152b2 of the transmitting side member 152 and the engaging claws 151d of the transmitted side member 151 can be reliably maintained when the transmitting side member 152 rotates in the forward direction P, and the amount of the ingredient sent to the container C by the ingredient sending means 134 can be accurately managed.

Further, when the weight of the ingredient I distributed to the container C reaches the predetermined distribution weight, the control unit closes the discharge opening 131a by the shutter 136 and then releases the engagement between the transmitting side member 152 and the transmitted side member 151. Thereby, when the weight of the ingredient I distributed to the container C reaches the predetermined distribution weight, the shutter 136 closes the discharge opening 131a and then the engagement between the transmitted side member 151 and the transmitting side member 152 is released. Thus, when the weight of the ingredient I distributed to the container C reaches the predetermined distribution weight, the ingredient I will not spill out of the ingredient stocker 131 into the container C, and the ingredient I can be automatically distributed to the container C in an accurate amount.

Modified Example

Although the ingredient distribution device 100 according to one example of the present invention has been described above, the ingredient distribution device according to the present invention is not limited to the ingredient distribution device 100 according to the above-described example.

For example, in the above-described example, the ingredient distribution device 100 is controlled by input via the touch panel 113, but a communication means may be provided to control the ingredient distribution device 100 by remote operation from the outside.

### REFERENCE SIGNS LIST

100 ingredient distribution device
110 base
120 housing
121 housing main body
121a opening
122 lid
123 touch panel
124 driving light
130 ingredient distribution unit
131 ingredient stocker
131a discharge opening
131b ingredient drop hole
131c swing shaft
132 hopper
133 ingredient measuring means
133a container placing table
133b load cell
134 ingredient sending means
134a coil-shaped material
134b connecting shaft
135 ingredient stirring means
135a stirring member
135a1 engagement hole
135b geared rotating shaft
135b1 engagement protrusion
136 shutter
136a shutter main body
136b connecting bolt
136c shutter pivoting mechanism
136c1 plunger
136c2 housing
136c3 connecting plate
140 drive unit
141 drive motor
142 rotating shaft
143 drive gear
143a helical teeth
150 clutch unit
151 transmitted side member
151a connecting shaft side cylindrical portion
151b flange portion
151c transmitted side cylindrical portion
151d engaging claw
151d1 forward direction abutment surface
151d2 opposite direction abutment surface
152 transmitting side member
152a gear
152a1 helical teeth
152a2 key groove
152b engagement cylinder
152b1 key
152b2 engaging claw
152b2a forward direction abutment surface
152b2b opposite direction abutment surface
153 helical spring (biasing member)
154 pushing member
154a pin
154a1 small diameter tip portion
154a2 large diameter portion
154b solenoid
154b1 plunger
154c arm
154d frame
155d roller bearing
F placement surface
C container
I ingredient
R rotation axis
P forward direction
N opposite direction
θ1 inclination angle of forward direction abutment surface
θ2 inclination angle of opposite direction abutment surface

1. An ingredient distribution device comprising:
a plurality of ingredient distribution units that store ingredients and can distribute the ingredients to containers;
a drive unit that generates power for driving the ingredient distribution units;
clutch units, which are the same number as the ingredient distribution units, that control transmission of the power generated by the drive unit to the ingredient distribution units; and
a control unit that controls operating the ingredient distribution units, driving the drive unit, and the transmission of the power by the clutch units.

2. The ingredient distribution device according to claim 1, wherein the drive unit has a drive motor that generates the power and drive gears, which are the same number as the ingredient distribution units, that are provided on a rotating shaft that rotates integrally with the drive motor,
the ingredient distribution unit has an ingredient stocker that stores the ingredient, an ingredient measuring means, on which the container is placed, that measures weight of the ingredient distributed to the container, and an ingredient sending means that sends the ingredient stored in the ingredient stocker to the container, and
the clutch unit has a cylindrical transmitted side member that engages with a rear end of a connecting shaft of the ingredient sending means, a cylindrical transmitting side member that engages with the drive gear of the drive unit on an outer circumferential surface thereof and is engageable with the transmitted side member in the longitudinal direction, and a pushing member that pushes the transmitting side member to the transmitted side member based on control of the control unit to engage the transmitted side member and the transmitting side member with each other.

3. The ingredient distribution device according to claim 2, wherein the clutch unit has a biasing member that biases the transmitting side member in a direction in which the transmitted side member and the transmitting side member separate from each other.

4. The ingredient distribution device described in claim 2, wherein the transmitting side member and the transmitted side member have sawtooth-shaped engaging claws that engage with each other in the longitudinal direction,
the engaging claws of the transmitting side member and the transmitted side member have forward direction abutment surfaces, which abut each other when the transmitting side member is rotated in a forward direction in which the ingredient sending means is driven in a direction in which the ingredient is sent to the container, and opposite direction abutment surfaces, which abut each other when the transmitting side member is rotated in a opposite direction opposite to the forward direction, and
the forward direction abutment surface of the engaging claw intersects with the rotation axis of the transmitting side member or the transmitted side member in a side view, and an inclination angle of the forward direction abutment surface is gentler than an inclination angle of the opposite direction abutment surface.

5. The ingredient distribution device according to claim 2, wherein the ingredient distribution unit has a shutter for opening and closing a discharge opening formed in the ingredient stocker,
the control unit controls opening and closing of the discharge opening by the shutter, and
when weight of the ingredient distributed to the container reaches predetermined distribution weight, the control unit closes the discharge opening by the shutter and then releases engagement between the transmitting side member and the transmitted side member.
